(19) United States
(12) Patent Application Publication
(10) Pub. No.: US 2026/0230474 A1
(43) Pub. Date: Aug. 6, 2026

(54) Construction of the Internet.

(71) Applicant: Yuka Kawashita, Tokyo (JP)

(72) Inventor: Yuka Kawashita, Tokyo (JP)

(21) Appl. No.: 19/576,098

(22) Filed: Mar. 24, 2026

(30) Foreign Application Priority Data
Apr. 21, 2024 (JP) JP2024-79771
Mar. 25, 2025 (JP) JP2025-50837

(51) Int. Cl. H04L 9/40

(52) U.S. Cl. CPC H04L 63/0884

(57) ABSTRACT

The present invention provides a new construction of the Internet to remove the defect and the technical and the social structural issues of the conventional Internet. In detail, the construction consists of the licenses for sending information to the public and the addresses whose authorities are limited to read and one by one write tasks virtually except for tasks through emergency system.

### BACKGROUND OF THE INVENTION

The general and broad use of the Internet started in around 2000 and many people started to send information to the public using the Internet by setting up their own home pages, for example. After the era, the Internet has grown continuously and the Internet has brought us many benefits.

On the other hand, the increasing number of people has been infringed their human rights and nowadays the Internet has become the object that brings us pains and threats after over 20 years from its spread. The conventional Internet structure itself has made many victims with no doubt. It is necessary to face the fact that people become easy to encounter crimes.

The 2010s was the era of SNSs'growing, and now we are facing the spread of AI under the risks of the Internet. It is known that the benefit brought by SNSs highly depends on each one's purpose of use and also unfortunately it is well known that relatively many people don't use SNSs in healthy ways. For example, also in view of the world, in the use of SNSs in the field of groups or politics, the outside people have easily suffered from infringements of their various human rights by the groups or the politics, and SNSs have turned out to be tools for helping discriminations and crimes. Also, in the field of market, the same problems such as frauds have occurred.

In addition, because AI structurally needs much existing data, AI is easy to infringe various human rights such as portrait rights, copy rights, design rights, etc. as if the existence of AI itself would infringe those rights. Moreover, it is easy to image that those risks become higher when AI spreads under the existence of the Internet.

The issues of infringement of various human rights become threats in the world.

At around 2000, the Internet started its use in the way anyone could upload anything freely. We still use the structure.

Throughout the past 20 years, we have a lot of experiences to recognize that various crises happen because anyone including a person who don't belong to such company as mentioned in [0007] paragraph below, a person who don't use the Internet through companies, a person who don't have intelligence, a person whose job is crime, etc. can write anything on the Internet. Moreover, it is easy to understand from our experiences that not only the conventional Internet structure provides the increasing number of opportunities to meet criminals with the other criminals but also the Internet itself produces criminals. Especially, we can easily understand from our experiences that persons who scheme crimes are easy to connect.

Under the conventional structure of the Internet mentioned in the above [0004] paragraph, there are the only way that the victims (individuals, companies, etc.) negotiate the specified telecommunications service providers or the search engine steering companies to remove the contents directly or indirectly after they suffer from the contents (see non-patent literature 1 to 3). Recently, US has begun to think about legal regulation for children (for example by limiting the age, the use time, etc.), however, the objects are limited and the way is only by the law (see non-patent literature 4).

Historically, until the Internet generalization, there were not such threats because publications of information were covered and controlled by the publishing companies and the industry of broadcast which consists of intelligences autonomically depending on their corporate ethics under the Civil Code, the Copyright Act the Broadcasting Act, etc. In addition, extremely limited number of problems happened such as the issue focusing on a part of public figures, the issue caused by the rare mistake, etc. Moreover, those companies never exposed those issues to the public for long time nor engaged huge number of people in an indiscriminate attack without notice, let alone nor intentional issues, nor fake information. Depending on this manner, one issue rarely causes other issues.

In the legal point of view, although there have been basically the Construction, Civil Code, Penal Code and Commercial Code, and secondly Copyright Act, Design Act, and Trademark Act, and moreover Unfair Competition Prevention Act since 1995, Act on the Protection of Personal Information since 2003, Act on Promotion of Creation, Protection and Exploitation of Contents since 2004 (in Japan, for example), there are Internet users who don't want to learn those knowledges by themselves. Also, it always happens that there are Internet users or criminal syndicates who think they can get benefit if the victims won't notice, who think they can get benefit if the victim won't sue, who are simplistic and think they may consider anything after the victim actually sue them, who think they can be sued, who think they can earn until the victim actually sue them or who think they can earn if the number of lawsuits increases, notwithstanding that they know the above mentioned laws.

Although it may be possible that we control the problem contents by the law against the search engine steering companies, it is too strict to impose duties on them because over around 3 billion Internet users (the number is provided by the Japanese Ministry of Internal Affairs and Communications on their web site) can upload anything anytime freely under the conventional Internet structure and it is impossible to control those people who are not employees of the companies. It will be impossible to perform the duties even if they are actually imposed the duties because of the insufficiency of persons in charge of the performance.

Exemplified Google uses AI to remove the problem contents, but unfortunately, it looks like an examination of in-complete AI without consent of the public and it is too late to wait the completion of AI as a person. Consequently, AI won't be enough to fulfill the duties. Especially, there are risks to use AI in the field of human rights and business deals. In addition, there are possibilities that the public peace gets worse because most people don't have enough mechanistical knowledge of AI and therefore nor its limit nor how to face its incompletion, and then people will feel stresses against AI. AI can be only assistance.

In view of the profit-making companies, it will be unavoidable that they will make the border profit-first or they will welcome information or advertisements including the problem contents as many as they can even if we impose an inevitably vague regulation on those profit-making companies including Google, etc. because they earn from our information or advertisements especially. In addition, after the enforcement of the Act on Promotion of Competition for Specified Smartphone Software (Mobile Software Competition Act) and making additional charge by the Act, there will be vicious cycle that they will cut personnel for removing problem contents relating to various human rights.

As mentioned above, there has not been the construction to control people who send various human rights infringing information to the public through the Internet including various crimes.

### BACKGROUND ART

[Non-Patent Literature 1] Google support (https://support.Google.com)

[Non-Patent Literature 2] JIJI. com, “Google removes 5.5 billion problematic advertisements, up 6% from previous cases, strengthening its countermeasures with generative AI”, Mar. 28, 2024 (https://www.jiji.com/jc/article? k=2024032800150&g=int&utm_source=yahoo&utm_medium=referral&utm_campaign=link_back_edit_vb)

[Non-Patent Literature 3] AERAdot., “90 doctors sue the Google, because of leaving ill information by word of mouth, “Suffered”, Also the case to trample down the doctor's fee,”, Feb. 29, 2024 (https://dot.asahi.com/articles/-/214869?page=1)

[Non-Patent Literature 4] JIJI. com, “Spread of SNSs regulation for children Worrying about bad influence to their mental-US”, Mar. 27, 2024 (https://www.jiji.com/jc/article?k=2024032700741&g=int)

[Non-Patent Literature 5] NIKKEI News Paper, “The policy of increasing the number of lawyers is at a turning point; the Ministry of Internal Affairs and Communications recommends a review, citing concerns about a decline in quality due to oversupply.” to the Ministry of Justice and the Ministry of Education, Culture, Sports, Science and Technology”, Apr. 20, 2012 (https://www.nikkei.com/article/DGXNASFS1903H₌Q2A420C1MM0000/)

### BRIEF SUMMARY OF THE INVENTION

A serious defect of the conventional Internet structure that the ability to delete the contents belongs to only the senders and a social structural issue between technical and legal are disclosed. The defect and the issue have caused various human rights infringements and losses for long time. The present invention provides a new construction of the Internet to remove the defect and the technical and the social structural issues. In detail, the new Internet construction consists of the licenses for sending information to the public and the addresses whose authorities are limited to read and one by one write tasks virtually except for tasks for emergency. The new Internet construction provides positive effect to many fields such as not only individual daily life or crime or crisis prevention but also economics, marketings, industries, statistics of the public opinion, national government, antimonopoly, money laundering prevention and so on.

### BRIEF DESCRIPTION OF THE SEVERAL VIEWS OF THE DRAWINGS

FIG. 1, FIG. 2, FIG. 3 and FIG. 6 are macroscopic outline figures of the new Internet construction of the present invention. FIG. 4 and FIG. 5 indicate the conventional Internet structure. White area means the authority is virtually only read and one by one write tasks. Black area means the authority is write tasks to do the concerned writings to the public in addition to the above tasks. FIG. 6 is one of the examples of the control organization of the concerned licenses.

### DETAILED DESCRIPTION OF THE INVENTION

### Conventional Technical Issues

Compared to the former way such as books, journals, TV or radio, the Internet particularly spread the information extremely broadly and extremely fast and makes the information stayed in public in such a wide society permanently as long as the writer (sender) doesn't delete the content itself. In addition, the social trust or the social rights of the individuals or the companies are weak compared to the powers brought by the size of society mediated by the Internet, the permanency or the fixation of the information mediated by the Internet and the multiplication of the information mediated by the Internet, and then easily destroyed by the Internet. Under such circumstances, it is too late to delete the problem contents after the victims have noticed them. In addition, there is an issue that the victims suffer worse and worse because the real deletion ability belongs to the only senders, and then the senders hold real powers.

If the criminals, criminal syndicates, the specified telecommunications service providers or the search engine steering companies don't delete or remove the problem contents, there is a way that the victims sue them. But the lawsuit takes long time and costs high, and moreover there lurks issues that if the victims need to state preservation of evidence, the problem contents concerning the various human rights continue to stay in public through the Internet until the end of the lawsuit.

It always happens that victims decide to avoid lawsuits or pay money (e.g., so-called “removal business”) if the offenders are strangers or strange organizations whose job might be crimes rather than have relationship with them to prevent more crisis by them or to avoid knowing each other.

And also, it always happens that there must be persons who feel easy from one's unhappiness and one of them causes another one who infringes various human rights of others endlessly. The conventional Internet structure is easy to connect those people, easy to influence those people each other and easy to increase the number of those people. Those properties are well known human nature considering the existence of the word “thief at a fire”, the fact that the brutal crime date is near the other same kind brutal crime date and the fact that the number of crises and various human right infringement is increasing behind displaying crises image day by day through the Internet.

Today, we have got knowledge from the long experience of using the Internet that SNSs make children grow worse (non-patent literature 4). Moreover, because children are not learning enough to judge, the very children tend to suffer from crimes.

The way of thinking that is used in controlled goods (Article 48 of the Foreign Exchange and Foreign Trade Act) is also helpful. We must not provide high level technologies including the factors that can be used badly to the persons who behave against public order and standards of decency.

The economic losses which people devote energy, times and costs to recover the damage against these infringements of various human rights within their limited life time are big. Even if there are people who earn behind those ill contents, they infringe public order and standards of decency. To make each people have more freedom and more profitable and creative times and be fully active within his or her limited life time is necessary for human further prosperity. And also, by making the human profitable Internet's circumstances be more healthy and fully active, to make communication instead of division and to make the world truly wealthy are fruitful results which contribute to the development of the industry.

Some fundamental approaches to solve those issues are indispensable considering that the number of people in the world is around 8 billion compared to the recent number of the Internet users is around 3 billion as mentioned above. And also, there is a social structural issue that the background of the administrative persons or judicial persons who can know whole problems is the humanities and social sciences, and then they don't try to find technical and structural solutions from the beginning.

### Best Mode for Carrying Out the Invention

The present invention provides the licenses to send information to the public through the Internet. The present invention provides the Internet construction in which people can't send information to the public through the Internet unless they get the license. As setting the licenses, the present invention provides the addresses whose tasks are limited to read tasks and one by one write tasks virtually.

Above mentioned sending information to the public through the Internet means setting up home pages, etc., writing on boards or SNSs, selling goods, sending advertisements, and the like, through the Internet (hereinafter referred to as “the concerned writings”.).

The concerned license is not limited to things which need legal examination like so called qualifying examination or some examinations. But if setting those kinds, the contents relate to the Internet and various human rights.

In more detail, the examination contents include the Internet factors which make infringement of those rights get worse. The factors are, for example, the information spread range of the Internet and the fact that the information on the Internet stay in the range and people can see it permanently, etc.

In view of law, the examination contents for the concerned license include, originally, a part of the Construction concerning the human rights, prohibition of the discrimination, etc. and the corresponding part of Civil Code, Penal Code and Commercial Code, and especially, Broadcasting Act, Act on the Protection of Personal Information and the related laws, Copyright Act, Design Act, Trademark Act, etc. Further, Unfair Competition Prevention Act, Protection and Exploitation of Contents, Act on Specified Commercial Transactions, Secondhand Goods Business Act, Nuisance Prevention Ordinance, and the like (in Japan, for example). Of course, the contents are pursuant to establishments of new Acts and the alterations and the abolitions of above Acts. Act on the Limitation of Liability for Damages of Specified Telecommunications Service Providers and the Right to Demand Disclosure of Identification Information of the Senders, for example, can be abolished after the concerned license is established. Especially, in view of the clause about Demands for Disclosure of Identification Information of the Senders (especially, clause 5), the Act should be abolished because it involves risks to make ordinal persons who don't have weapons and powers connect with unknown strangers. We have to consider well whether the Act on the Limitation of Liability for Damages of Specified Telecommunications Service Providers and the Right to Demand Disclosure of Identification Information of the Senders should be included to the license or not (in Japan, for example). It is effective that the contents include a range of Curriculum Guidance for Defining the Basic Standard for Education or Government Guidelines for Education (in Japan, for example) which is approximately equal to the compulsory education about the above fields. In view of the rights, the contents include the field of various human rights including personal rights, portrait rights, privacy rights, the rights to control personal information, rights to be forgotten, rights to disconnect, moral rights, copyrights, design rights, trademark rights, etc. (hereinafter referred to as “the concerned various human rights”.). For confirmation, these Acts depend on each country.

Preferably the examination contents for the concerned license include the content that copyright is not a thing which needs registration but a thing originally belongs to a person who has created the work for the first time. And also, the examination contents for the concerned license preferably include the content that board users or SNS users must not use the other persons'personal information who don't agree with its privacy policy and its terms of the service.

Or the examination contents for the concerned license include the relationship between the Internet and the concerned various human rights. For example, leaving the information which infringes the concerned various human rights in public for long time makes the loss of victim's social trust and social rights get worse and worse, etc.

Or the examination contents for the concerned license include questions which make the candidates select whether the example can be published to the public through the Internet, SNSs, etc.

Or, the examination contents for the concerned license include questions which, as a major premise, enhance the recognition that people including the candidates must not infringe various human rights of others who are innocent and who have not attacked against the candidates.

Or the examination contents for the concerned license include questions which make the candidates explain the problem points of the provided current events or mock cases about the field of the Internet or the various human rights. The editorials are the most effective.

Or the examination contents for the concerned license include the combination of above contents.

The control organization of the concerned license is preferably a kind of Japan Broadcasting Corporation (Broadcasting Act, Chapter 3) or Broadcasting Ethics and Program Improvement Organization (in Japan, for example). This is possible because nowadays broadcasting also uses the Internet and they are overlapped. However, if they are too busy, they can be limited to advisers or partners and preferably a new organization is established depending on the standard which is equal to article 6 through 7 of the Broadcasting Act which relates to the Deliberative Bodies for Broadcast Programs and article 30 through 41of the Broadcasting Act which relates to the Board of Governors of Japan Broadcasting Corporation. Also, because nowadays there are issues also in the field of broadcasting in view of ethics, the organization is preferably jointly controlled by the Ministry of Education, Culture, Sports, Science and Technology (especially, the board of education) and the private sector (in Japan, for example).

The concerned license includes not only certificates, laws or contracts, but also ID-level personal information, addresses, domain names, keys, codes, electronic certificates, sets of ID and password, programs, pricings, or the selections and/or the combination of above examples. The name is not limited to above examples if it has the same function with them.

The examples mentioned in the following [0042] paragraph such as the personal information which passed the control gate by the ID-level identification and recognition and/or the success in the quiz which is set in advance of making the account for the SNS, log-in to the SNS, and/or writing on the SNS and/or the examples mentioned in the following paragraph such as the addresses and/or domain names which passed the supplemented filter by the techniques of the sharing of information and/or the change of information for identification are also examples of the concerned license.

Above mentioned addresses whose authorities are limited to read tasks and one by one write tasks virtually (hereinafter referred to as “the concerned address” in this paragraph) include conventional IP addresses whose tasks are limited by the concerned license, IP addresses or the new name addresses whose tasks are limited by the program, however it is not limited to above examples if it has the same function with the concerned address.

The example mentioned in the following [0042] paragraph such as the address which is used by a person (or a terminal) who has gone the site after the setting of the gate which needs the ID-level identification and recognition is also an example of the concerned address. And also, the address which belongs to a failure person in the quiz which is set in advance of making accounts for the SNS, log-in to the SNS, and/or writing on the SNS is also an example of the concerned address. And also, the address which belongs to the removed writing after the setting of the control step which deletes already existing concerned writings by persons who have not showed their ID or who have not passed the quiz for the specified period of time (for example, in public for around one week to one month from the end of the period) is also an example of the concerned address. (By the way, for confirmation, this doesn't mean that we can distinguish the person who has disturbed the policy of the law up to the moment because the address also includes the address which belongs to a person who quit SNSs taking this opportunity. If we want to distinguish the person, we will need to compare the problem address to the other receiving information or focus on the high frequency address.) And also, the address which is blocked by the filter mentioned in the following paragraph is also an example of the concerned address.

As to the age by which people can get the concerned license, the present invention sets the limitation. For example, the limitation is over the age 14 depending on the knowledge acquired in U.S. so far (non-patent literature 4). However, because this is a mere example, the age is not limited to above age and appropriate age to the laws and/or the education system of each country is preferred.

Also, the present invention sets buffers in which people under the age can write with administrator such as their parents, guardians, or representatives because usage of the Internet is various.

The construction in which people can't send information to the public through the Internet without getting the concerned licenses consists of the concerned licenses and the addresses whose authorities are limited to read and one by one write tasks virtually.

The construction preferably includes the organization or the program in which the concerned license holders watch each other and can warn and delete preparing for violations by themselves. The concerned license holders include the control organization of the concerned licenses. And also, the concerned construction preferably includes the organization or the program which can stop the concerned license of the offenders. Above mentioned organization or the program to watch, warn and delete each other includes the system in which the concerned license holders are all required to report the infringe contents found to the control organization of the concerned license, for example.

The concerned license also preferably includes the system controlled by not only the address but also several lock strategies in the house in which the concerned license holders and non-holders stay together because address is provided one for several persons such as one for the family, etc. For example, the address which is provided to the family which consists of several persons including the holders of the concerned license is the one mentioned in the claim 2, and then the concerned license holders use another type of the license which needs recognition by the control organization when the holders do the concerned writings using the family terminals.

If it is necessary, in view of efficiency and not making escape route, the construction preferably includes a step in which, by preparing over two kinds of address name (or program) for each conventional IP address, etc., the Internet service providers (ISP) or the Japan network information center (JPNIC) (in Japan, for example) select address name (or program) and provide address for a person depending on his or her license type because conventional addresses have not been portable and people have changed the addresses depending on the various turning points. To make the name which can be seen by the user be different from the real address name can be effective in avoiding human application error or cutting routes in which malicious users use the real address directly, and therefore it can be effective in making the concerned licenses stronger. Considering the fact that the IPv6 has reached 128 bits, the unique letters of each country can be used for the new address names.

The address renewal process preferably includes random re-providing process if the conventional IPv4 address is used because many people have already seen their own IP address.

As mentioned in and after the following [0045] paragraph, because we are in the transition era from IPv4 to IPv6, the renewal addresses are preferably produced using IPv6 taking opportunity of making the concerned license. And also, the process preferably includes a system in which IP address control organization shares the table for comparing the previous address to the renewal address with the search engine steering companies because leaks from the conventional filters may be happen depending on the position of the search engine steering companies in the Internet. Taking this opportunity, the process also preferably includes checking filter leaks of the search engine steering companies in the transition process from IPv4 to IPv6and if the leaks are detected, the process preferably includes sharing the table for comparing IPv4 to IPv6 with the search engine steering companies.

In view of effective use of the Internet space and preventing unexpected malicious use of the IP addresses, more preferably, the addresses are portable, that is, the address is fixed to the person, especially in the field of private Internet address contracts. For example, the way to fix is that ISP or JPNIC connects the concerned unique personal address to the corresponding address by using programs depending on the license presented by the person, etc.

If the above portable address is adopted in the new Internet construction or if ISP, JPNIC, the new control organization of concerned license, etc. judge that they can control certainly by human operation in the conventional system in which the address is fixed to the family or the fixed terminal, the option provided in above [0037] paragraph will not be necessary.

Although the concerned license is not limited to the address, there may be scenes in which people can't write on SNSs using LAN or free Wi-Fi without their direct contract if the concerned license is the address, but it will not matter because many SNS users can use their own smart phone to write on SNSs. However, it is known that people often write on SNSs at their visiting places although the frequency depends on each person, and therefore preferably the concerned licenses which are assigned to public facilities are not address type but another type to un-lock. For example, the address provided for the public facilities is the address mentioned in the claim 2, and above concerned license holder use the recognition which needs check by the control organization of the concerned license, etc.

If the system mentioned in the present invention is adopted in many countries, people may feel annoy because every time people visit another country and write, every time they have to get the concerned license of the country. However, the minor adjustment like visa or car license will be possible in which the concerned licenses are provided to short-term visitors after they simply pass the short examinations, etc.

If the system mentioned in the present invention is adopted in only Japan, it is preferable to set similar type partial deregulation because foreign visitors who don't have the concerned license of Japan will be puzzled and suffered from unexpected uselessness of SNSs. For example, the strategy is the control organization of the concerned license provides them with special recognition for short-stay visitors by the application on the entry, etc.

Emergency will not matter because it is preferable to take measures by which people can write without the concerned license in the case of the emergency facilities or the emergency sites. For example, the specification for the emergency facilities and/or the emergency sites are the one mentioned in the claim 1 and they always permit accesses and the concerned writings of all people by using programs, etc.

The transition term for gradual shift from conventional structure of the Internet to the construction which consists of the concerned license is necessary. To explain more clearly, picking up only boards or SNSs, after the presentation of the future license policy and the necessity of transitional measure, the organization begins the process including (A) simply and easily, the organization makes the administrators of the boards or SNSs require the users not to make the accounts, login or write if the users haven't passed the ID-level personal information distinction and recognition, (A′) in the same way, the organization makes them require the users not to make the account, login or write if the users have not passed the specific quiz from the policy of the concerned boards or SNSs, (B) in the same way, the organization requires the concerned boards or SNSs to delete the concerned writings which are made by the users who haven't passed (A) or who haven't passed (A′) for specified period of time after around one week to 1 month from the end of the period, and then (C) at around the time the formal examination for the concerned license has established, the organization shifts the rights for concerned writings wholly simply from for all to for the holders of the concerned license for example by requiring the recognition in advance of the concerned writings while remaining escape route to the conventional Internet structure, (D) finally, the organization shifts all authorities from (C) to the control system in which authorities are basically controlled by address completely. Because the issue should be solved near future, it is preferable to take such a transitional measure on a case-by-case basis, but it is more preferable to set the specified moment until which the new Internet construction consists of the concerned license completely while controlling unfair or chaos caused by escape routes. Above mentioned escape route means that malicious specified telecommunications service providers may not fulfill the duty or malicious users may hunt the malicious specified telecommunications service providers or make malicious boards or malicious SNSs by themselves.

The invention disclosed in JP2025-78325 and/or JP2025-101714 can be applied to the transition term.

The process for transition to the concerned license system includes steps or programs in which the concerned license holders or the control organization of the concerned license delete the sites which have not been updated for long time or lost their owners and have risks to be taken over during the switching period.

Because conventional specification in which anyone can write anything originally depends on the fact that IANA (a part of ICANN at present) provides such addresses (ref. https://www.icann.org/ja/about/agreements/iana/functions-basics-08apr14-ja.pdf), there is an fundamental way to solve escape issues in which people ask IANA to make and provide new addresses having different authority, that is, to make and provide around two or three kinds of addresses, for example the one which is allowed only read tasks or read tasks and one by one write tasks virtually and the one which is allowed the concerned writing tasks in addition to them. Although the present invention includes such addresses and the construction of the Internet which consists of the addresses made by asking IANA, it is possible for each country to control tasks independently by programs against real addresses because there have been already framework such as JPNIC or ISP in each country or assigned addresses to each country have a rage originally and the fact means there have been already independent networks of each country.

To image the present invention easily, as a mere example, explaining by picking up the addresses called multi cast address which has existed in addition to standard addresses since the period of IPv4 and the addresses called global unicast address which is standard in the period of IPv6, global unicast address is used as a basic specification and then only multi cast address is used for the concerned writings and make the latter have license in the construction of the present invention.

Because when users write on the Internet boards or SNSs, the process includes automatic program in which the concerned specified telecommunications service providers deliver the writings to the public, if we use the previous paragraph's example to explain this case, the construction of the present invention impose obligation to set permanent program which blocks the information from the global unicast addresses on the concerned specified telecommunications service providers. In the case selling goods or sending advertisements, considering the revealed issues, because the process may be various and some may include automatic program and the others may include the selection process by the specified telecommunications service providers, the construction of the present invention also impose obligation to set permanent procedures and/or programs which block the writings from the global unicast address on the concerned specified telecommunications service providers.

In the case of keys, codes, electronic evidence, or sets of ID and password as the concerned license, the construction of the present invention impose obligation to set the permanent programs to recognize the concerned license at the entrance of the concerned writings on the concerned specified telecommunications service providers.

It is effective to block information sent from global unicast addresses to multicast addresses at the level of ISP, JPNIC or the new control organization of the concerned license.

At the level of ISP, JPNIC or the new control organization of the concerned license, they can block information which infringes the concerned various human rights sent by foreign persons who don't have knowledge of the concerned country's domestic laws if they block the foreign global unicast addresses toward the concerned country's domestic multicast addresses. Also in this case, because it is common that people have friends staying in foreign countries and the communication tools are SNSs under nowadays highly globalization, not to block those communication routs unexpectedly may be an issue to clear, but above example is a mere example using conventional address names and it can be included in the range of fine adjustments of the present invention.

To say generally and simply, the construction includes programs which permit the sending information from the one mentioned in the claim 1 to another one mentioned in the claim 1 and block the sending information from the one mentioned in the claim 2 to the one mentioned in the claim 1, as to the concerned writings, for example. For confirmation, this doesn't mean the present invention excludes the construction in which after a person sends information from the one mentioned in claim 2 to the other one mentioned in claim 2 whose owner also has the one mentioned in claim 1, the owner or the organization sends the information using the one mentioned in claim 1 to the public after checking the contents and switching the way from the claim 2 one to the claim 1 one.

Because the way of using Internet is various depending on each country, there are merits to construct the system to adjust the authority of the address in each country independently without asking IANA to adjust. For example, explaining by using IPv6 standard global unicast addresses, in the construction of the present invention, programs to limit tasks are set on the sending side of the real addresses and then the addresses are connected to the Internet through the programs.

Especially, as to the contracts of personal Internet addresses, there already has been difference in the way of using the Internet such as 1: only reading, 2: reading and private writing on the site such as bank accounts, 3: in addition to the above example 2, writing on the boards and/or SNSs, 4: in addition to the above example 3, selling goods and/or sending advertisements, 5: in addition to the above example 4, making their own home pages. In view of large-scale organizations, there are more differences such as broadcasting, administration of bank accounts securities, watching or military affairs. Therefore, to supply each use with each unique programed address can provide profits for all nations and all industries in view of marketing by changing the price of each address contract, controlling the amounts of data communication and/or securities. As the above example 1 and 2 exist, whether people have the concerned license or not depends on mere difference of their selection. Moreover, there are a lot of people who don't make problems and who just don't select activity using the concerned license. Consequently, the concerned license is not a kind of thing putting one above the others. However, because only persons who truly need those activities do the concerned writings after the concerned license is enforced, setting the ranks and/or the specialization of the concerned license also brings good results for all people, for example.

After complete enforcement of the concerned license and the expulsion of the malicious specified telecommunications service providers and users, it is reasonable to assume that we can control the concerned license by the thig except for addresses by establishing the law which impose duty to recognize the concerned license at the entrance of doing the concerned writings on each specified telecommunications service providers, software for setting up homepages, etc. Although the present invention includes above construction, it is preferable to control tasks of addresses as a nation or at the level of IANA in order to avoid leaving holes for the infringements under co-existence of the conventional software for setting up homepages and/or conventional addresses provided by IANA.

On a case-by-case basis, as a long-term vision, there is an approach establishing the Internet construction by setting only read and virtually one by one write tasked computer as a standard and requiring recognition of the concerned license when people send information to the public. However, because placing the controller close to each individual's hands brings malicious persons chances to break it, it might be difficult to crack down on the offenders in this case. Consequently, it is preferable to control tasks of the addresses as a nation or at the level of IANA.

### Advantageous Effects of the Invention

At least, people who don't have knowledge of the concerned various human rights and/or who don't read laws, rules, etc. can't send information to the public using the Internet. Malicious persons who can't reveal their identity (e.g., criminal syndicate members) stop sending information to the public using the Internet.

As a result, especially, we can prevent indiscriminate infringements, including crimes, of the concerned various human rights of innumerable people. The circumstance of the Internet becomes healthy, crimes and/or violence decrease, and then we become able to take full advantage of the Internet for economics and industries. The quality of information on the Internet improves. Not only the victims but also watch persons become able to spend their times or expense on more free, healthy, profitable, creative and quality activities. At least, we become able to prevent giant IT company from getting unfair income, and then we become able to recover fair distribution. Consequently, those effects contribute to a healthy development of the industries.

Because the quality of information on the Internet gets better from the beginning, the frequency of the infringements becomes lower. Moreover, as to the relationship between people and the search engine steering companies, because the search engine steering companies can't run in the business target countries without the concerned license, they have to remove the problem contents depending on the caution by the control organization of the concerned license. In this way, we become able to reflect the target countries'laws, public order and standards of decency, public opinion and customs in those companies'borders more correctly than before. Thus, the decision of removal gets more quickly. The control organization of the concerned license also becomes able to delete the problem contents directly instead of the search engine steering companies. As a result, proper recoveries of public order become faster and these results contribute to healthy developments of economics.

### INDUSTRIAL APPLICABILITY

In addition to above [0048] and [0049], setting the national examination of the concerned license make the country profitable. In the same way, because people gain special authority to send information to the public, demanding application fee of the concerned license is within the range of justice and this way also makes the country profitable. Of course, there are cases in which the money enters from the other countries. In view of Japan, Japan can make profits from the other countries if Japan gets rights of the concerned license in those countries or Japan sell products of the concerned license to them. In view of Japan, the present invention contributes to the traditional worldwide image “Japan is safe”. As a result, the nation can increase its income through the fruitful cycle. In this way, the economics and the social security become wealthy. Public order gets better. In this way, people become able to spend creative and quality times and contribute to the development of the industries. Generalization of the concerned license makes the world getting better.

Although the concerned license is not limited to the one which needs examination, if some examination is set for the concerned license, people can get chance to receive lifelong education of this field. Although the concerned license is not limited to the one which needs examination, if the examination is set each country, people can deepen mutual understanding in advance. Those results also contribute to the stabilization of the national government and prevention of conflicts and wars, and then contribute to the development of economics and industries.

In another view, to establish the construction of the Internet depending on the concerned license, its control organization become necessary. And also, the present invention contributes to the development of the industry surrounding the concerned license, such as the techniques of making the concerned license more effectively, the techniques of making the concerned virtually only read and one by one write tasked address more effectively, the surrounding techniques to establish the new Internet construction by using above techniques more effectively, etc. In this way, the present invention brings the development of the techniques of the field and the techniques for reinforcement continuously. The related techniques also grow. On the whole, the present invention contributes to the development of the industry.

Because people generally tend to avoid lawsuits against strangers especially from the beginning, the conventional Internet structure makes the problems built up potentially. And also, because people generally tend to avoid lawsuits against strangers especially from the beginning, to increase the number of human resources of the courts doesn't work to decrease those problems. Moreover, the increasement can't be achieved because of the budget. Consequently, the present invention makes more profits than the case in which the nation increases problems. Moreover, because the present invention is healthy, the present invention brings economics virtuous cycle. In view of lawsuits, the standard brought by the concerned license make the decision easier and brings quick resolution, and then people become able to live more comfortably. People become able to find more time for free, profitable, creative and high-quality activities. On the whole, the present invention contributes to the development of the industries.

In addition, the present invention brings us benefit that the country can grasp what percentage of the nations comment on the Internet, and then the statistics of the public opinion improves. And also, people can preserve the conventional way which is sometimes more effective than the Internet although people tend to miss the good points of them in era of the Internet. Furthermore, the present invention can be applied to countermeasures against tax collection error caused by the difference of the place between the domestic economic activity and the foreign settlement, money laundering and the like by adding fine adjustment which requires the candidate to open domestic account at the moment of applying for the concerned license for example. These results also contribute to the fair, healthy and various developments of the industries.

After the introduction of the construction mentioned in the present invention, a kind of fake site almost disappears from the beginning, but in order to prepare for the persons who try to slip through the construction, it become easy to develop the techniques for detecting them if globally IANA and domestically as to IP address ISP and JPNIC, and as to the domain name Japan Registry Service (JPRS, partial business transferred organization from JPNIC), VeriSign, Inc. relating companies, etc. (in Japan, for example) establish the route to share the IP addresses and the domain names or only the domain names if people decide to control only by using the IP addresses of the Internet server (solved by using the domain names) with the developer of the techniques. If the set of the domain name and the IP addresses (this includes not only the web server IP address which is used in the conventional DNS but also the other IP addresses which belongs to the organization or the person unless otherwise noted in this paragraph.) is not registered set (a set of a domain name and a IP addresses which belongs to the organization or the person who registered the domain name for the first time), we can easily recognize the detected set is false and the site is the fake site. As shown in the material mentioned in the above [0044] paragraph, basically, each DNS server controls the user visible site to be the formal site using the way in which if the user selects a specific domain name, DNS connect the user's IP address to the specific web server IP address. However, there are cases in which the user visible set (this is the set of the domain name displayed in the URL or the name of the organization displayed in the title and IP address which belongs to the real sender.) is not the registered set by using illegal means. Consequently, it is necessary to make the control system multi-layered in order to control user visible sites to be only formal ones. Establishing the control organization of the concerned license leads such supplemental development more easily. Similarly, the organization makes the operation of the supplemental detection system easy.

It is preferable to prepare systems to prevent incorrect redirect, etc. For example, it is preferable to prepare the systems in which by checking the IP address which belongs to the concerned site's information, if the address is not the address belongs to the domain name which is visible on the search results provided by the search engine steering companies, the systems block the former address. And/or, it is preferable to prepare systems in which if the domain name of the concerned site is not the same as the domain name belongs to the redirected site, the systems block the former domain name.

Additionally, it is also preferable to establish the system in which the domain name management organization and the IP address management organization share the table to compare the previous one with the renewal one with the search engine steering companies because leaks from the previous filters may happen depending on the position of the search engine steering companies inside the construction of the Internet. Taking this opportunity, it is also preferable to check whether the leaks from previous filter of the search engine steering companies have occurred or not in the transition process from IPv4 to IPv6, and then it is preferable to share the comparison table of IPv4 and IPv6 with the search engine steering companies if the leaks are detected.

More preferably the above techniques for detecting fake sites have the same purpose as the major part of the present invention, that is to detect and block the fake sites outside the user visible Internet from the beginning.

Namely, of course, the techniques mentioned in this paragraph can be applied to the transition term of the present invention.

### BRIEF DESCRIPTION OF DRAWINGS

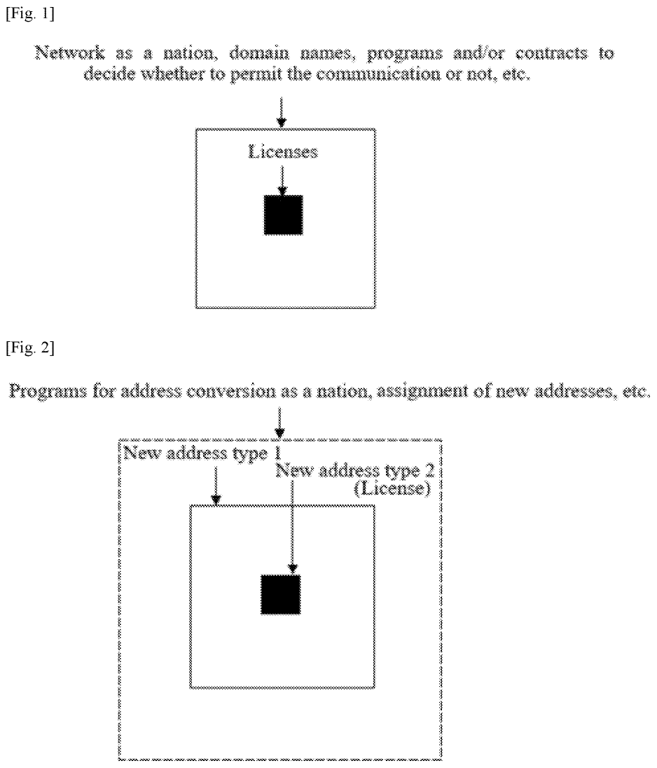

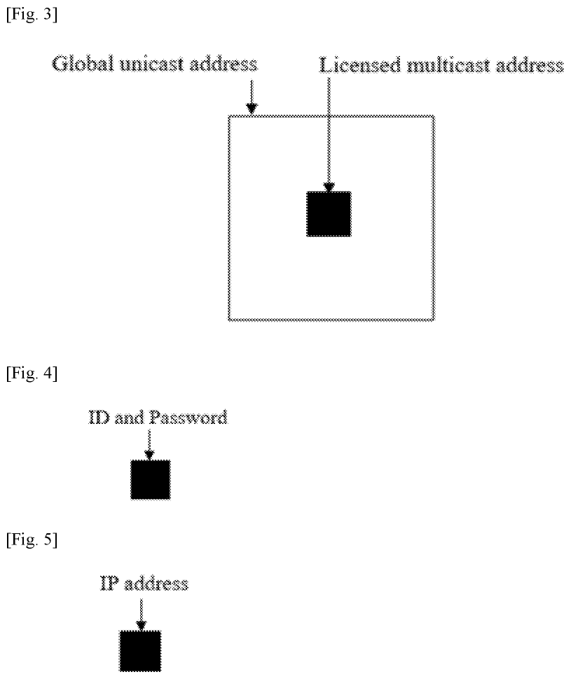

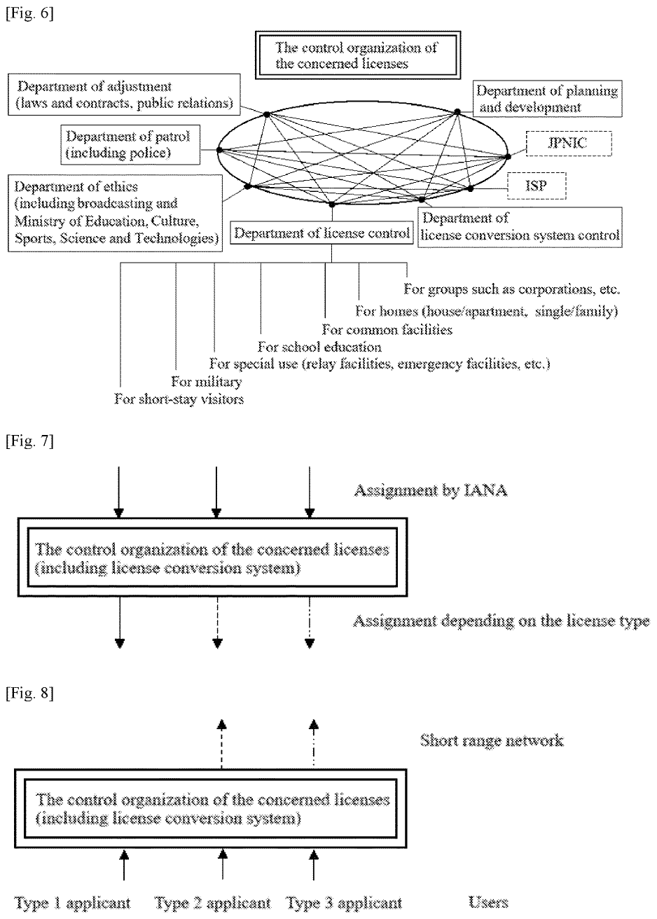

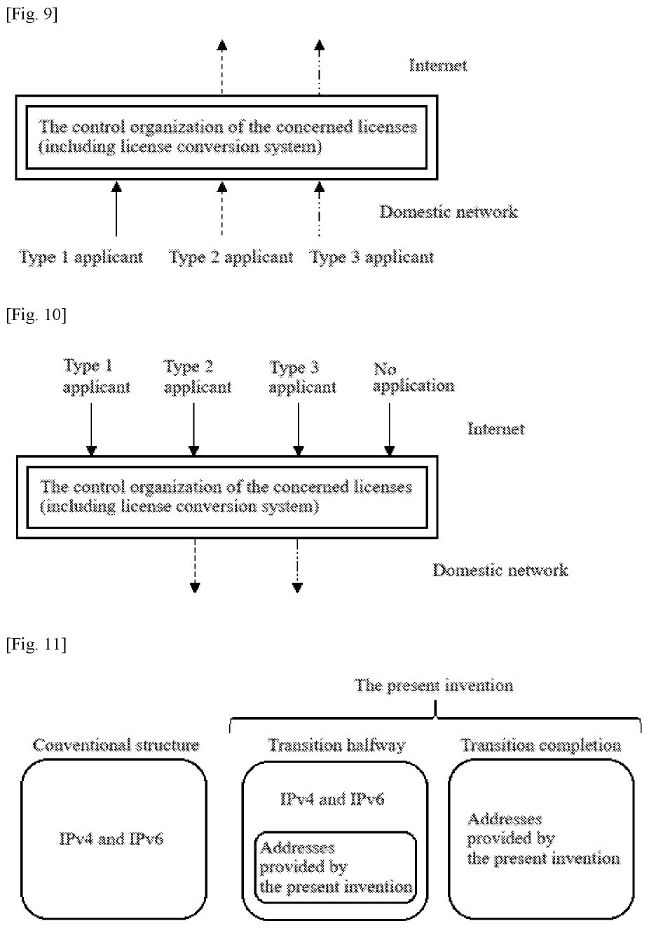

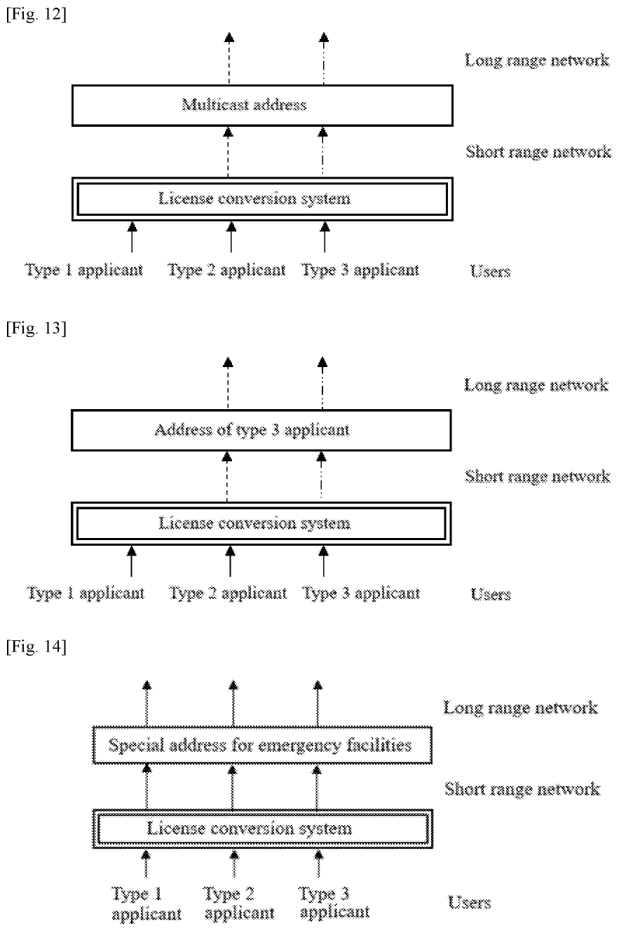

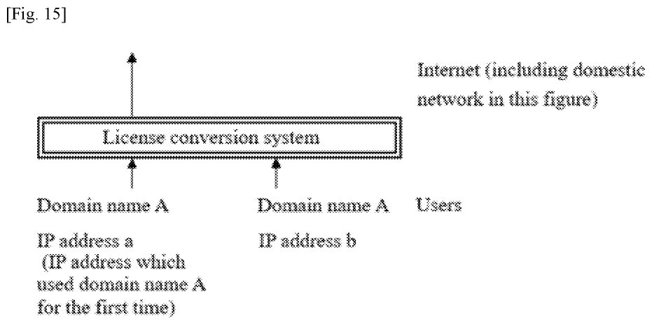

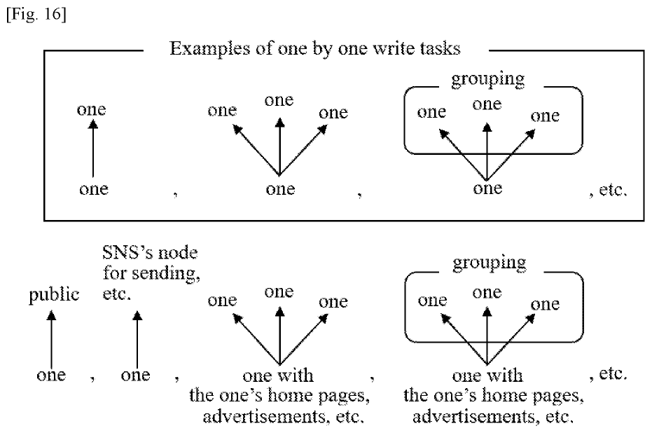

FIG. 1 One of the outline figures of the present invention

FIG. 2 One of the outline figures of the present invention

FIG. 3 One of the outline figures of the present invention

FIG. 4 Conventional SNSs

FIG. 5 Conventional Internet

FIG. 6 One of the examples of the control organization of the concerned licenses

FIG. 7 The relationship between addresses controlled by the license of the present invention and the control organization of the concerned license

FIG. 8 The relationship between the domestic communication controlled by the license of the present invention and the control organization of the concerned license (This is not an example of reading nor private communication but an example of the concerned writings.)

FIG. 9 The relationship between the communication toward foreign countries in which the concerned license is controlled by address and the control organization of the concerned license (This is not an example of reading nor private communication but an example of the concerned writings.)

FIG. 10 The relationship between communication from the foreign countries controlled by the concerned license of the present invention and the control organization of the concerned license (This is not an example of reading nor private communication but an example of the concerned writings.)

FIG. 11 The transition from the conventional Internet to the Internet of the present invention

FIG. 12 An application example of the present invention to boards or SNSs which use multicast address (This is not an example of reading nor private communication but an example of the concerned writings.)

The license conversion system in this figure is programs which don't connect the type 1 applicants'addresses with the multicast addresses as to the sending side communication tasks which are not permitted for the type 1 applicants but for the type 2 or 3 applicants (e.g., writings to the public, etc.), etc. Programs which don't connect the type 1 nor 2 applicants'addresses with multicast addresses as to the sending side communication tasks which are not permitted for the type 1 nor 2 applicants but for the type 3 applicants (e.g., sending advertisements, etc.), etc.

Another example is programs which impose specific recognition by the control organization of the concerned license when the type 2 or 3 applicants do the concerned writings under the specification in which the sending side of the basic ones mentioned in claim 2 are not connected to multicast addresses, etc.

FIG. 13 An application example of the present invention to boards or SNSs which use only global unicast addresses (This is not an example of reading nor private communication but an example of the concerned writings.). This Figure is an example of the case in which the boards and the SNSs are the type 3 applicants.

At first, the explanation is about the case in which the number of the types of the addresses provided to the boards or the SNSs (the type 3 applicants) is three (1: addresses for private communications, 2: addresses for the type 2 or 3 applicants available tasks (e.g., writings to the public, etc.), 3: addresses for the type 3 applicants available tasks (e.g., sending advertisements, etc.). In this case, the license conversion system in this figure is programs which don't connect the type 1 applicants'addresses with above 2 nor 3 and which don't connect the type 2 applicants'addresses with above 3, etc.

The next explanation is about the case in which the number of types of the addresses provided to the boards or the SNSs (type 3 applicants) is one. In this case, the license conversion system in this figure is programs which don't connect the type 1 applicants'addresses with the URLs which are permitted for the type 2 or 3 applicants to do the concerned writings (e.g., writings to the public, etc.) out of the URLs of the boards or the SNSs (type 3 applicants) and which don't connect the type 1 and 2 applicants'addresses with the URLs which are permitted for the type 3 applicants to do the concerned writings (e.g., sending advertisements, etc.) out of the URLs of the boards or the SNSs (type 3 applicants), etc.

Another example is the programs which impose specific recognition by the control organization of the concerned license when the type 2 or 3 applicants do the concerned writings under the specification in which the sending side of the basic ones mentioned in claim 2 are not connected to the boards or the SNSs (type 3 applicants)′ addresses and/or URLs which are permitted to do the concerned writings, etc.

FIG. 14 An example of the emergency system

The license conversion system in this figure is programs by which every type applicant's addresses can connect to the special address for emergency to do the concerned writings, etc.

FIG. 15 An example of the supplemental techniques for detecting fake sites

The license conversion system in this figure is programs which detect non-registered sets and block the communication outside the user visible Internet by comparing to the registered sets (i.e. the sets of domain name and the first IP addresses which belongs to the domain name) as to the sending side of the communication to do the concerned writings, etc. (In view of communication from foreign countries to the nation, the programs mean blocking at the entrance of the domestic Internet.).

FIG. 16 Examples of one by one write tasks

[caption] white area of FIG. 1 through FIG. 5: the authority is virtually only read and one by one write tasks., black area of FIG. 1 through FIG. 5: the authority is to do the concerned writings to the public in addition to the above tasks.

### DESCRIPTION OF EMBODIMENTS

[Example 1] Controlling the entrance of the concerned writings to the public through the Internet only for the concerned license holders, for example, the representative search engine steering company Google can assign the employees and money for removing 5.5 billion of sites per year now to more creative jobs only referring to advertisements as mentioned in the comparative example 1 below. The overtime works decrease. The scientists and technicians become able to concentrate on the creative and quality jobs and also have free, profitable, creative and quality private times. As a result, the present invention contributes to the development of the industries.

[Example 2] Controlling the entrance of the concerned writings to the public through the Internet only for the concerned license holders, the number of victims decreases and they become free from the restoration tasks, and then people become able to spend free, profitable, creative and quality times. People can use their money for free, profitable, creative and quality events. As a result, the present invention contributes to the improvements of the economic virtuous cycle and the development of the industries.

As mentioned in the above [0016] paragraph relating to conventional technical issues, because the number of the persons who accuse the offenders are small and there is a limitation of the manpower of the courts, there are no demerits for the courts and therefore nor for the country. Because there is a limitation of the manpower of the courts, there are also no demerits for the legal profession such as lawyers, etc. This is also because the courts'manpower should not be increased to keep the public peace before the generalization of the conventional Internet and to expect the healthy developments of economics. It is without saying that decrease of the so-called removal business doesn't matter for the development of the industries because they go against public order and standards of decency originally.

In view of technical fields surrounding the conventional Internet, the possibility of continuing anti-virus business is high because malicious persons who try to slip through the control using various techniques used to appear and the complete private Internet space (e.g., e-mail, Internet shopping, accounts of banks, intranet of companies, etc.) still exists. The manpower and the money remaining after the decrease of the malicious Internet task users can be shifted to the developments of the new techniques following the establishment of the new construction of the Internet controlled by the concerned licenses. Consequently, the present invention doesn't bring bad influence on those conventional fields.

[Comparative Example 1] The representative search engine steering company Google spends labor to remove 5.5 billion sites per year only referring to advertisements (see non-patent literature 2). The conventional structure of the Internet causes such big amounts of economic losses. As a result, it deprives not only victims but also scientists and technicians of their times, expense and energy for creative and quality jobs such as starting up new industries, etc. Also, it deprives them of their times, money and energy to have creative and quality times. Consequently, the conventional structure of the Internet causes losses of the development of the industries.

[Comparative Example 2] The specified telecommunications service providers or the search engine steering companies don't remove the problem contents quickly when the concerned various human rights infringed individuals, companies, etc. ask them to do so. Some specified telecommunications service providers or some Internet users scheme to earn commission using the way they don't remove the contents on the purpose and drive the victims into the so-called removal businesses. (An example of removal business by Internet users: non-patent literature 3 “They said, “Because Google also doesn't accept removal requests smoothly, patients threaten the hospital members who fear the low evaluation by them, and then “removal businesses” which take advantage of the hospital's weak points are rampant.”)

In view of the search engine steering companies, they remove the problem contents from the query certainly if the victims appeal to them to remove the problem contents logically. However, it takes long time to remove the problem contents because there are cases in which they use AI or the language of the person in charge of the request is not the language of the victim supposing from the fact that their removal system is open 24 hours and they don't disclose their personal name. Moreover, the removals by the search engine steering companies are not fundamental solution to the problem (i.e. not deletion) because the concerned problem sites still exist on the Internet space leaving the issues that malicious users can read the sites by direct access to the site's URLs even if the search engine steering companies remove the problem URLs from their search results.

[Comparative Example 3] When the concerned various human rights infringed individuals, companies, etc. accuse, they suffer from additional losses such as at least 2 to 3 months for the lawsuit and around 5 hundred thousand yen as the expense for lawyers besides there are risks that persons (individuals, companies, etc.) who don't have weapons and power like police link to the unknown strangers. If they appeal, the times, the costs and the labors accumulate. The conventional Internet structure causes such big economic losses. As a result, it deprives people of times, money and energy to spend creatively at work and at home. In this way, the conventional Internet structure causes losses of the healthy developments of the industries. (cf. non-patent literature 3 “group lawsuit”)

[Comparative Example 4] When the concerned various human rights infringed individuals, companies, etc. use the so-called removal business mentioned in the above [0016] paragraph relating to conventional technical issues, they have to pay 50 thousand to 2 hundred thousand yen per URL to the business. In fact, they lose more times, more costs and more labors because it always happens on the Internet that the URL is not the only one involved in the case. The conventional Internet structure causes such big economic losses. As a result, it deprives people of times, money and energy to spend creatively at work and at home. In view of the so-called removal businesses, they think they can earn easily by the simple action, writing and making the copies, and they can earn more and more money if they increase the number. In short, they think they can earn easily by increasing the number. Consequently, the public order and standards of decency is disrupted in the world. In this way, the conventional structure of the Internet causes losses of the healthy developments of the industries. (An example of the so-called removal business by malicious users: non-patent literature 3 “They said, “Because Google also doesn't accept removal requests smoothly, patients threaten the hospital members who fear the low evaluation by them, and then “removal businesses” which take advantage of the hospital's weak points are rampant.”)

1. Licenses for sending information to the public through the Internet.

2. Addresses whose authorities are limited to virtually read and one by one write tasks except for tasks through emergency system.

3. The construction of the Internet which consists of the things mentioned in above claim 1 and 2.
